(19) United States
(12) Patent Application Publication
(10) Pub. No.: US 2005/0049845 A1
(43) Pub. Date: Mar. 3, 2005

(54) Verification and characterization of noise margin in integrated circuit designs

(75) Inventors: You-Pang Wei, Los Altos, CA (US); Yuhung Liao, Sunnyvale, CA (US); Mingchi Liu, Santa Clara, CA (US); YuJiao Ping, Santa Clara, CA (US)

Correspondence Address: BURNS DOANE SWECKER & MATHIS L L P, POST OFFICE BOX 1404, ALEXANDRIA, VA, 22313-1404, US

(73) Assignee: Legend Design Technology, Inc., Santa Clara, CA (US)

(21) Appl. No.: 10/729,701

(22) Filed: Dec. 5, 2003

Related U.S. Application Data
(60) Provisional application No. 60/497,972, filed on Aug. 25, 2003.

(51) Int. Cl. G06F 17/50

(52) U.S. Cl. 703/15

(57) ABSTRACT

In accordance with the present invention there is provided a method of simulating a memory circuit design in order to verify the signal strength of bit lines. The method begins by identifying circuit elements of the memory circuit design. Next, a memory circuit path is extracted from the circuit elements. The memory circuit is simulated and the maximum voltage difference between bit lines is measured. The maximum voltage difference is measured to a noise margin in order to verify the signal strength of the bit lines.

### RELATED APPLICATIONS

The present application claims the benefit of U.S. Provisional Application No. 60/497,972 entitled “RELIABILITY-BASED CHARACTERIZATION SYSTEM IN IC/SoS DESIGNS” filed Aug. 25, 2003, the entire contents of which are incorporated herein by reference.

### FIELD OF INVENTION

The present invention generally relates to computer aided methods and tools for designing, simulating, characterizing and verifying integrated circuit (IC) designs, and more particularly to a system and method for verifying and characterizing the noise margin of signals within such designs.

### BACKGROUND OF THE INVENTION

The design of very large-scale integrated (VLSI) circuits using computer aided design (CAD) systems is a very time consuming and computationally intensive process. As the complexity of VLSI circuit design has increased, circuit designers have begun incorporating basic circuit building blocks into circuit designs so that the designers do not need to start from scratch for each design. This design approach is commonly referred to as an intellectual property (IP) based design approach and the basic circuit building blocks are referred to as IP blocks.

In accordance with system on chip (SOC) technology, a variety of circuit building blocks are incorporated onto a single integrated chip. Each of the building blocks performs a specific function of an electronic system. The IP building blocks include, but are not limited to, embedded memory, standard cell, I/O devices, analog and system interfaces, etc. . . .

A timing model including many characterized timing parameters for each IP block that is to be incorporated into a system chip is required by the IC designers. Important timing parameters include setup time, hold time, access time, minimum pulse high and low time, and other I/O pin characteristics. Designers are interested in characterizing and optimizing timing characteristics associated with an IP block design.

There are two methods of IP block characterization and verification. The first method is based on ‘full circuit’ simulations. For deep submicron designs, a netlist size of layout-extracted IP blocks could be enormous with a large number of resistors and capacitors. It might be prohibitive to run numerous full circuit simulations with a high-accuracy circuit simulator. The other method is a characterization based on ‘critical-path circuit’ simulations. Instead of using a full circuit, a small detailed critical circuit including multiple critical paths is used of simulation. The ‘critical-path circuits’ are built either manually or by software tools for automation, accuracy and performance.

The simulation results observed during the characterization process are only at the pins of the full circuit or at ports of the ‘critical-path circuit’. Reliability issues such as noise margin, glitch, and racing conditions that occur inside the circuit are normally ignored. Accordingly, the timing parameters generated by the simulation may be too optimistic and incorrect.

Furthermore, the circuit or subcircuit block is viewed as a biack-box when the circuit simulation is performed. However, the simulations results observed at the pins cannot detect the above-mentioned reliability issues that can occur inside the circuit. The models based upon simulation and characterization results could be incorrect thereby causing yield and reliability problems.

### SUMMARY OF THE INVENTION

The present invention is a characterization system that provides a noise margin check on signals or the maximal differences of relevant signals with specified tolerances in determining timing characteristics of a circuit.

In accordance with the present invention there is provided a method of simulating a memory circuit design in order to verify the signal strength of bit lines. The method begins by identifying circuit elements of the memory circuit design. Next, a memory circuit path is extracted from the circuit elements. The memory circuit is simulated and the maximum voltage difference between bit lines is measured. The maximum voltage difference is measured to a noise margin in order to verify the signal strength of the bit lines.

Additionally, there is provided a method for characterizing a minimum clock cycle time against a noise margin in a memory circuit design. The method comprises identifying circuit elements and extracting a memory circuit path. Next, the memory circuit is simulated with a maximum initial clock cycle time. The memory circuit is also simulated with a minimum initial clock cycle time. If both of the simulations are successful, then the minimum clock cycle time is valid.

### BRIEF DESCRIPTION OF THE DRAWINGS

These, as well as other features of the present invention, will become more apparent upon reference to the drawings wherein:

FIG. 1 is a flowchart illustrating how a voltage differences are compared to a noise margin in a circuit simulation.

FIG. 2 is a block diagram of a sense amplifier.

FIG. 3 is a graph illustrating a comparison of voltage differences between bit and bitb lines for the sense amplifier shown in FIG. 2.

FIG. 4 is a flowchart showing how to characterize a minimum clock cycle time against a noise margin.

FIG. 5 is a block diagram of a sense amplifier without a sense amplifier enable line.

FIG. 6 is a graph illustrating a comparison of voltage differences between bit and bitb lines for the sense amplifier shown in FIG. 5.

### DETAILED DESCRIPTION

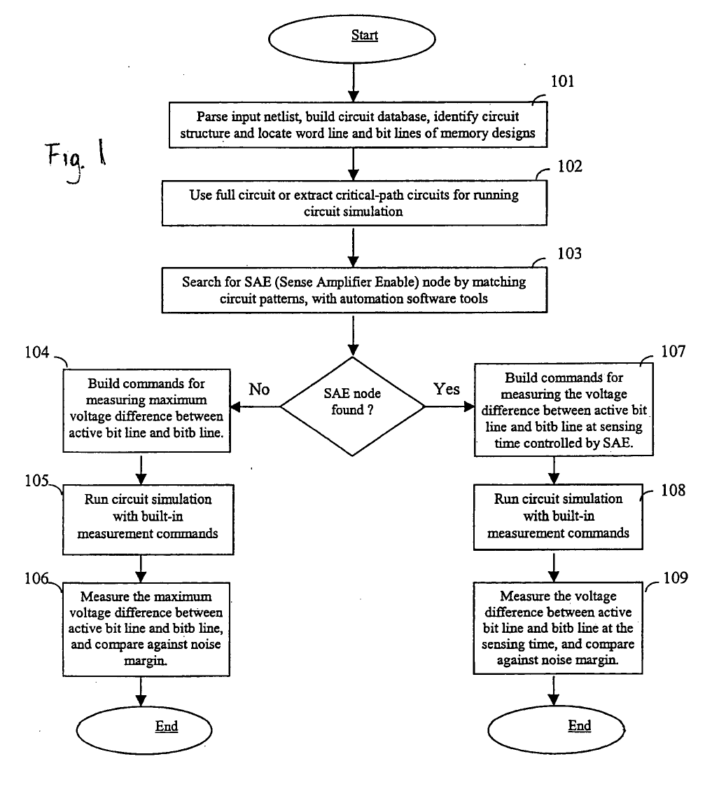

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. The instructions of a computer program as illustrated in FIG. 1 for verification of signal strength versus noise margin can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer readable-medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

The present invention generally relates to Applicants' co-pending patent applications: “TIMING SOFT ERROR CHECK”, Attorney Docket No. 033994-003; “RELIABILITY BASED CHARACTERIZATION USING BISECTION”, Attorney Docket No. 033994-004; and “GLITCH AND METASTABILITY CHECKS USING SIGNAL CHARACTERISTICS”, Attorney Docket No. 033994-005, filed concurrently herewith and the entire contents of each application are incorporated herein by reference.

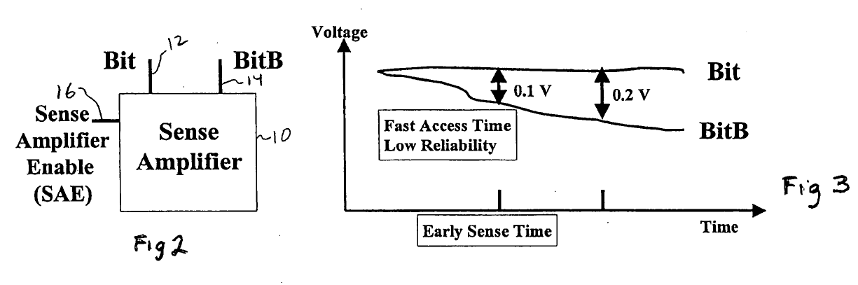

Referring now to the drawings wherein the showings are for purposes of illustrating preferred embodiments of the present invention only, and not for purposes of limiting the same, FIG. 1 is a flowchart illustrating an automatic method of identifying sense amplifier inputs and verifying the sensed bit-bitb voltage difference against a noise margin in memory designs. Referring to FIG. 2, a sense amplifier 10 having a bit line 12 and a bitb line 14 is shown. The sense amplifier 10 is a basic building block used in the design of memory circuits. A sense amplifier enable (SAE) line 16 is also an input to the sense amplifier 10 and controls the time when the voltage on the bit line 12 and the bitb line 14 are sensed. If the voltage difference between the bit line 12 and the bitb line 14 at sensing time (as controlled by the SAE line 16) is less than the noise margin for the signals, then the reliability of the signals can be in question. Therefore, it is advantageous to verify the sensed bit-bitb voltage against the noise margin in memory designs.

Referring to step 101 in FIG. 1, the process of verifying the bit-bitb voltage begins parsing the input netlist of the circuit under consideration. A circuit database is then built and circuit structures are identified therefrom. The word and bit lines of memory designs are then located from the circuit database. Next, either a full circuit or a critical-path circuits are identified that will be used for running circuit simulations in step 102. For simulation performance or feasibility, a software tool (i.e., SpiceCut) can be used to create a critical-path netlist. For memory designs, the netlist will contain row decoder, active word lines, active bit lines, memory cells, and sense amplifiers, as well as data input and output buffer circuits. It will be recognized that a full circuit can be used for simulation, but will be slower because it is larger than critical-path netlists.

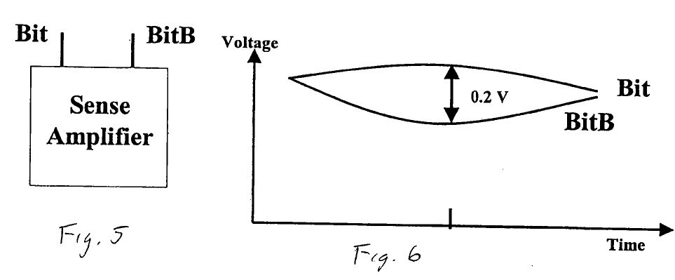

In step 103, the SAE (Sense Amplifier Enable) nodes are searched. The nodes are identified by matching circuit patterns with known patterns for the nodes with automation software (i.e., SpiceCut). Alternatively, the nodes can be identified manually. If a SAE node is not found, then the process proceeds to step 104 where commands for measuring the maximum voltage difference between active bit lines and bitb lines are built. FIGS. 5 and 6 illustrate the situation where a SAE node is not found. An automation software tool (e.g., MemChar) will create input stimulus and the commands for measuring the maximum voltage difference between the active bit line and the bitb line. In step 105, the circuit simulation is run with the measurement commands built in step 104. The maximum voltage difference between the active bit line and the bitb line is measured in step 106. Furthermore, the maximum voltage difference is compared with the noise margin in step 106 in order to characterize the voltage signal.

If an SAE node is found in step 103, then the process proceeds to step 107 where commands for measuring the voltage difference between the active bit line and the bitb line at sensing time controlled by the SAE are built. In this regard, the commands measure the voltage difference at a time controlled by the sense enable line 16. The automation software tool creates input stimulus and commands for measuring the voltage difference at sensing time controlled by SAE. Also, the measurement commands for the SAE delay time (from clock to SAE delay time) will be generated in step 107. Next, in step 108, the circuit simulation is run with the given input stimulus and measurement commands from step 107. In step 109, the voltage difference between the active bit line and the bitb line at the sensing time controlled by the SAE node is measured from the simulation run in step 108. The voltage difference determined is compared against the noise margin. Also, the SAE delay time (from clock to SAE delay time) will be reported.

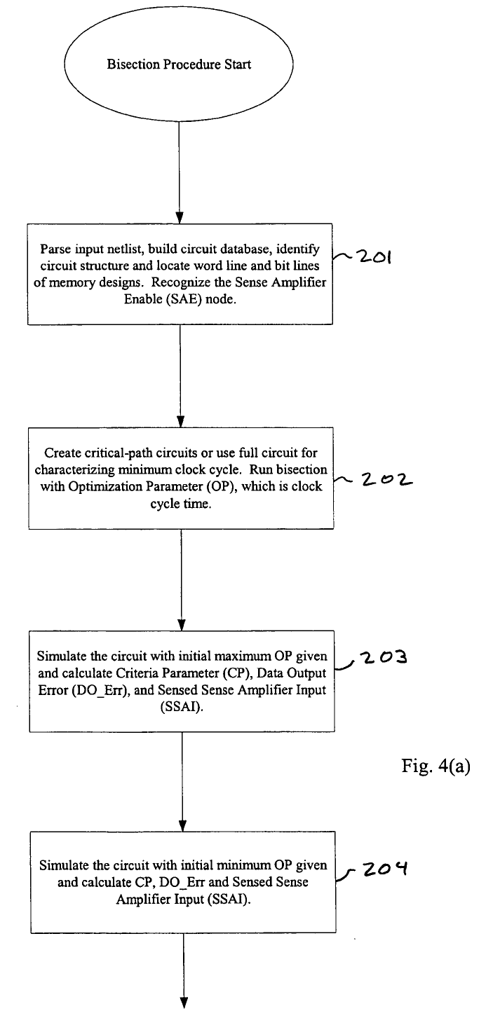

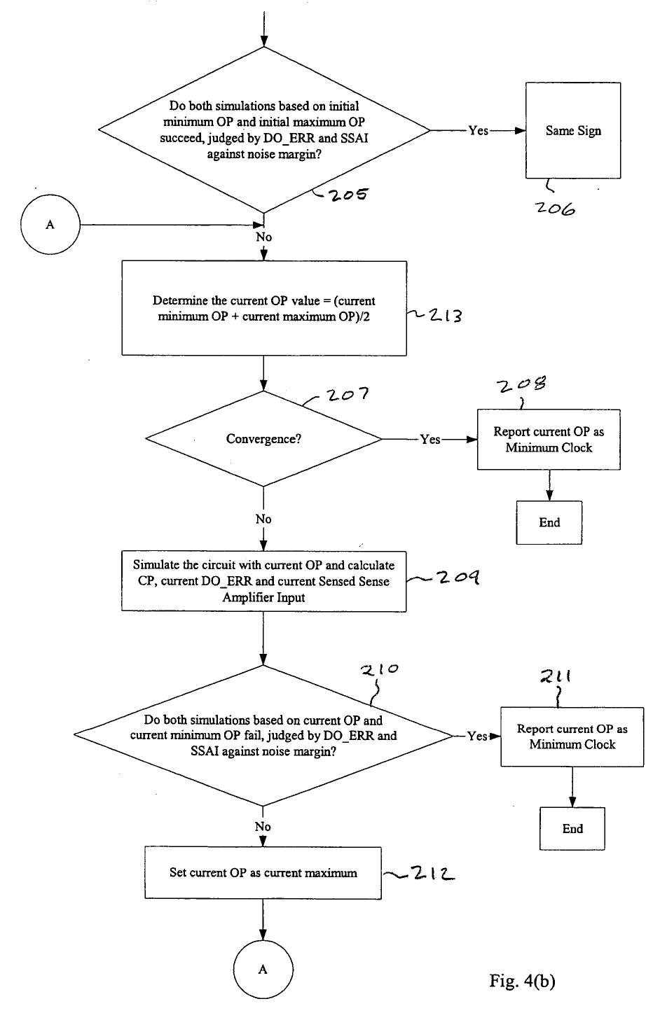

Referring to FIG. 4, the method for characterizing a minimum clock cycle time with the reliability checking of sensed sense amplifier inputs against a noise margin in memory designs is shown. The method begins by parsing an input netlist and building a circuit database in step 201. Furthermore, circuit structures are identified from the circuit database and word and bit lines of the memory are located therefrom. In step 201, any sense amplifier enable (SAE) nodes are also found. In step 202, critical-path circuits are created for characterizing a minimum clock cycle with an automated software tool such as SpiceCut. Alternatively, a full circuit can be used for characterizing the minimum clock cycle with an increase in processing time. For memory designs, the circuit will include row decoder, active word lines, active bit lines, memory cells, sense amplifier, as well as data input and output buffer circuits. A bisection is run on either the critical-path circuit or the full circuit using an Optimization Parameter (OP) that is equal to the clock cycle time. The OP is the clock cycle time (Tcycle) which indicates the clock cycle time where the circuit design operates.

The circuit created in step 202 is simulated in step 203. Specifically, the circuit is simulated with an initial maximum OP in order to calculate a Criteria Parameter (CP), a Data Output Error (DO_Err), and Sensed Sense Amplifier Input (SSAI). An automated software tool will call a simulator to simulate the circuit based on the initial maximum Optimization Parameter (OP) that is the maximum clock cycle time. The Data Output Error (DO_Err) is calculated to determine whether the Data-Out pins switch correctly or not. The DO_Err has to be less than a prescribed value (such as 0.1*Vdd) for the success of the simulation. The Sensed Sense Amplifier Input (SSAI is defined as the voltage difference of active bit and active bitb at the sensing time if the SAE node exists or the maximum voltage difference of active bit and active bitb lines if the SAE node does not exist. Next in step 204, the circuit is simulated with the initial minimum OP and the CP, DO_Err and the SSAI.

Referring to step 205 it is determined whether the simulations succeed. Specifically, the DO_Err is checked to see if it less than a prescribed value (such as 0.1*Vdd) in both steps 203 and 204. Also, the SSAI is checked to see whether it is greater than the noise margin. If either one of these conditions is not true, then the simulation proceeds to step 213 to begin the process of an iterative bisection. However, if both conditions are true, then the iterative process of bisection cannot continue because the same sign error in step 206 and the process stops.

In step 213, a current OP is determined to be the average of the current minimum OP and the current maximum OP. In step 207, it is determined whether there is convergence within the circuit. Specifically, convergence is based upon whether the current CP is within a specified error tolerance. If convergence is reached, then in step 208, the current OP is the minimum clock and the process stops. However, if convergence is not reached, then the circuit is simulated with the current OP and the CP, DO_Err and current SSAI is calculated in step 209. In step 201, it is determined whether the simulations have succeeded in the same manner as step 205. If the simulations have succeeded then the process continues to step 211 where the current OP is the minimum OP and the process returns to point “A” for iterative bisection. However, if the simulations fail, then in step 212, the current OP is set as the maximum OP and the process proceeds to point “A” for iterative bisection. As will be recognized by those of ordinary skill in the art, at point “A”, the process will continue until there is convergence in step 207.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method of simulating a memory circuit design in order to verify the signal strength of bit lines, the method comprising the steps of:
identifying circuit elements of the memory circuit design;
extracting a memory circuit path from the circuit elements;
simulating the memory circuit;
measuring a maximum voltage difference between bit lines; and
comparing the maximum voltage difference between bit lines to a noise margin to verify the signal strength of the bit lines.

2. The method of claim 1 wherein the voltage difference between bit lines is the voltage difference between bit and bitb lines.

3. The method of claim 1 further comprising the step of identifying sense amplifier enable node after extracting the memory circuit path.

4. The method of claim 3 further comprising the step of measuring the voltage difference between bit lines at a sensing time controlled by the sense amplifier enable node.

5. The method of claim 4 further comprising the step of comparing the voltage difference between bit lines to a noise margin at the sensing time to verify the signal strength of the bit lines.

6. The method of claim 5 wherein the voltage difference between bit lines is the voltage difference between bit and bitb lines.

7. A system for simulating a memory circuit design in order to verify the signal strength of bit lines, the system comprising:
a computer configured to execute the following instructions:
identify circuit elements of the memory circuit design;
extract a memory circuit path from the circuit elements;
simulate the memory circuit;
measure a maximum voltage difference between bit lines; and
compare the maximum voltage difference between bit lines to a noise margin to verify the signal strength of the bit lines.

8. The system of claim 7 wherein the voltage difference between bit lines is the voltage difference between bit and bitb lines.

9. The system of claim 7 wherein the computer is further configured to identify a sense amplifier enable node after extracting the memory circuit path.

10. The system of claim 9 wherein the computer is configured to measure the voltage difference between bit lines at a sensing time controlled by the sense amplifier enable node.

11. The system of claim 10 wherein the computer is configured to compare the voltage difference between bit lines to a noise margin at the sensing time to verify the signal strength of the bit lines.

12. The system of claim 11 wherein the voltage difference between bit lines is the voltage difference between bit and bitb lines.

13. A method of characterizing a minimum clock cycle time against a noise margin in a memory circuit design, the method comprising the steps:
identifying circuit elements of the memory circuit design;
extracting a memory circuit path from the circuit elements;
simulating the memory circuit with a maximum initial clock cycle time;
simulating the memory circuit with a minimum initial clock cycle time;
calculating the criterion parameter for the simulations; and
determining whether the simulations are successful to determine if the minimum clock cycle time is valid.

14. The method of claim 13 further comprising the steps;
determining a new clock cycle time if the simulations are not successful;
simulating the memory circuit with the new clock cycle time; and
determining whether the simulations are successful to determine if the minimum clock cycle time is valid.

15. The method of claim 14 comprising the steps of repeatedly determining a new clock cycle time, simulating the memory circuit with the new clock cycle time and determining whether the simulations are successful until the criterion parameter converges to a prescribed value.

16. The method of claim 14 wherein the simulations are not successful if a data output error of the simulation is above a prescribed value.

17. The method of claim 14 wherein the simulations are not successful if a voltage difference between bit and bitb lines of the memory circuit is less than the prescribed noise margin.

18. A system for characterizing a minimum clock cycle time against a noise margin in a memory circuit design, the system comprising:
a computer configured to execute the following procedure:
identify circuit elements of the memory circuit design;
extract a memory circuit path from the circuit elements;
simulate the memory circuit with a maximum initial clock cycle time;
simulate the memory circuit with a minimum initial clock cycle time;
calculate a criterion parameter for the simulations; and
determine whether the simulations are successful to determine if the minimum clock cycle time is valid.

19. The system of claim 18 wherein the computer is configured to further execute the following procedure;
determine a new clock cycle time if the simulations are not successful;
simulate the memory circuit with the new clock cycle time; and
determine whether the simulations are successful to determine if the minimum clock cycle time is valid.

20. The system of claim 19 wherein the computer is configured to repeatedly determine a new clock cycle time, simulate the memory circuit with the new clock cycle time and determine whether the simulations are successful until the criterion parameter converges to a prescribed value.

21. The system of claim 20 wherein the simulations are not successful if a data output error of the simulation is above a prescribed value.

22. The method of claim 20 wherein the simulations are not successful if a voltage difference between bit and bitb lines of the memory circuit is less than the prescribed noise margin.

23. A method of characterizing a minimum circuit parameter sensitive to a noise disturbance against a noise margin in a circuit design, the method comprising the steps:
identifying circuit elements to be characterized;
extracting a critical path netlist from the circuit elements;
simulating the critical path netlist with a maximum initial value of the parameter under characterization;
simulating the critical path netlist with a minimum initial value of the parameter under characterization;
calculating a criterion parameter;
determining whether the simulations based on the initial minimum and maximum values of the parameter under characterization indicate the same status; and
ceasing simulation if both simulations indicate the same status.

24. The method of claim 23 further comprising the steps:
determining a current value of the parameter under characterization that is half the sum of the maximum initial and minimum initial values of the parameter;
simulating the critical path netlist with the current value of the parameter and determining against the noise margin whether the simulation indicates a success or failed status;
setting the current value of the parameter to the current minimum value of the parameter if both simulations based on the two values of the parameter indicate the same status; and
setting the current value of the parameter to the current maximum value of the parameter otherwise.

25. The method of claim 24 comprising the steps of repeatedly determining a new current value of the parameter under characterization, simulating the critical path netlist with the new value of the parameter and determining against the noise margin whether the simulations indicate a success or failed status until the criterion parameter converges to a prescribed bisection.

26. The method of claim 24 wherein the simulation indicates a success or failed status if a data output error of the simulation is above a prescribed threshold.

27. The method of claim 24 wherein the simulation indicates a failed status if the measured noise is above the prescribed noise margin.

28. A system for characterizing a minimum value of circuit parameter against a noise margin, the system comprising:
a computer configured to execute the following procedure:
identify circuit elements of the circuit to be characterized;
extract a critical path netlist from the circuit elements;
simulate the critical path netlist with a maximum initial value of the parameter under characterization;
simulate the critical path netlist with a minimum initial value of the parameter under characterization;
calculate a criterion parameter;
determine whether the simulations based on the initial minimum and maximum values of the parameter indicate the same status; and
halt operations if both simulations indicate the same status.

29. The system of claim 28 wherein the computer is configured to further execute the following procedure:
determine a current value of the parameter that is half the sum of the maximum initial and minimum initial values of the parameter;
simulate the critical path netlist with the current value of the parameter and determine against the noise margin whether the simulation indicates a success or failed status;
set the current value of the parameter to the current minimum value of the parameter if both simulations based on the two values of the parameter indicate the same status; and
set the current value of the parameter to the current minimum value of the parameter otherwise.

30. The system of claim 29 wherein the computer is configured to repeatedly determine a new value of the parameter under characterization, simulate the critical path netlist with the new value of the parameter and determine against the noise margin whether the simulation indicates a success or failed status until the criterion parameter converges to a prescribed value.

31. The system of claim 30 wherein the simulation indicates a failed status if a data output error of the simulation is above a prescribed threshold value.

32. The system of claim 30 wherein the simulation indicates a failed status if measured noise is above the prescribed noise margin.

33. A method of simulating and determining an optimized circuit parameter simultaneously, the method comprising the following steps:
defining a circuit path of the circuit;
simulating the circuit path with the parameter under characterization; and
determining whether the parameter under characterization is optimized with the circuit simulation.

34. The method of claim 33 wherein the circuit is simulated with a new parameter under characterization until the parameter under characterization is optimized.

35. The method of claim 33 wherein the parameter under characterization is optimized when a bisection error of the circuit simulation is within a prescribed range.

36. The method of claim 35 wherein the parameter under characterization is a signal strength of a prescribed signal.
